(19) United States
(12) Patent Application Publication
(10) Pub. No.: US 2012/0314198 A1
(43) Pub. Date: Dec. 13, 2012

(54) METHODS OF ESTIMATING POINT SPREAD FUNCTIONS IN ELECTRON-BEAM LITHOGRAPHY PROCESSES

(76) Inventors: Sang-Hee Lee, Yongin-si (KR); Byung-Gook Kim, Seoul (KR); Hee-Bom Kim, Hwaseong-si (KR); Soo-Young Lee, Auburn, AL (US); Qing Dai, Auburn, AL (US)

(21) Appl. No.: 13/486,064

(22) Filed: Jun. 1, 2012

(30) Foreign Application Priority Data
Jun. 10, 2011 (KR) 10-2011-0055887

(51) Int. Cl. G03B 27/32

(52) U.S. Cl. 355/77

(57) ABSTRACT

In a method of estimating a PSF in the electron-beam lithography process, a linear resist test pattern may be formed on a substrate. A line response function (LRF) may be determined using a cross-sectional profile of the linear resist test pattern. A development rate distribution in a first direction, the first direction may be substantially perpendicular to an extending direction of the linear resist test pattern, may be calculated using the LRF. A line spread function (LSF), which may represent an exposure distribution in the first direction, may be calculated using the development rate distribution. The PSF may be estimated using the LSF.

### CROSS-RELATED APPLICATION

This application claims priority under 35 U.S.C. §119 to Korean Patent Application No. 10-2011-55887, filed on Jun. 10, 2011 in the Korean Intellectual Property Office (KIPO), the entire contents of which are herein incorporated by reference.

### BACKGROUND

1. Field

Example embodiments relate to a method of estimating point spread functions in an electron-beam lithography process. More particularly, example embodiments relate to a method of estimating point spread functions that may be capable of reflecting developments generated in an electron-beam lithography process.

2. Description of the Related Art

Generally, a point spread function (PSF) may be used for profile prediction of a resist, proximity effect correction, etc., in an electron-beam lithography process. The PSF may be approximately obtained using Monte Carlo simulation and Gaussian function.

Further, a fitting process for correcting errors of the obtained PSF may be performed in order to obtain an accurate PSF.

### SUMMARY

At least one example embodiment provides a method of estimating a PSF in an electron-beam lithography process.

According to some example embodiments, there is provided a method of estimating a PSF in an electron-beam lithography process. In the method of estimating the PSF in the electron-beam lithography process, a linear resist test pattern may be formed on a substrate. A line response function (LRF) may be determined using a cross-sectional profile of the linear resist test pattern. A development rate distribution in a first direction, the first direction may be substantially perpendicular to an extending direction of the linear resist test pattern, may be calculated using the LRF. A line spread function (LSF), which may represent an exposure distribution in the first direction, may be calculated using the development rate distribution. The PSF may be estimated using the LSF.

In one example embodiment, the forming the resist test pattern may include forming a resist film on the substrate, exposing the resist film using an electron-beam, and developing the exposed resist film.

In one example embodiment, the determining the LRF may include measuring depths from points on a first axis of the first direction to a sidewall of the linear resist test pattern.

In one example embodiment, the determining the development rate distribution may include determining a first vertical development rate at a central point of the resist test pattern in the first axis, determining a second vertical development rate at a second point shifted from the central point, determining a horizontal development rate at the second point, determining a depth error between a depth of the resist test pattern calculated using the vertical distribution rate and the horizontal distribution rate at the second point, and an actual depth of the resist test pattern, correcting the second vertical development rate and the horizontal development rate until the depth error is lower than a threshold value, if the depth error is higher than the threshold value, and determining the development rate distribution based on the second vertical development rate and the horizontal development rate.

In one example embodiment, the determining the development rate distribution may further include determining a depth of the linear resist test pattern at the center point by multiplying the first vertical development rate and a developing time.

In one example embodiment, the determining the development rate distribution may further include determining a depth of the linear resist test pattern at the second point by summing d_{V}(xi) and d_{L}(xi), wherein d_{V}(xi) is a vertical depth distribution profile at the second point and d_{L}(xi) is a horizontal depth distribution profile at the second point.

In one example embodiment, the determining a depth of the linear resist test pattern including determining the d_{L}(xi) based on development rates at each of points between the center point and an endpoint of the resist test pattern in the first direction.

In one example embodiment, the second point may include points between the center point and an endpoint of the resist test pattern. Calculating the development rates at the second point may include calculating the development rates at each of the points from the center point to the endpoint.

In one example embodiment, the determining the LSF may include using an exposure and development rate transform formula.

In one example embodiment, the determining the LSF may include calculating an exposure dose at each of points from the center point to an end point using the development rates in the first direction determined by the exposure and development rate transform formula.

In one example embodiment, estimating the PSF may include calculating an exposure dose at each of the points based on distances between the center point and points, determining a matrix A, wherein e=A×p, e being the LSF and p being the PSF, based on the distances, and inducing the PSF using the matrix A and the exposure distribution.

In one example embodiment, the determining the LSF may include summing exposure doses at exposed points of the linear resist test pattern.

In one example embodiment, the determining the LSF may include calculating only front scatterings, if the linear resist test pattern includes a single line.

In one example embodiment, the determining the LSF may include summing front scatterings and rear scatterings, if the resist test pattern includes a plurality of lines.

At least another example embodiment discloses a method of estimating a point spread function (PSF). The method includes determining a cross-sectional profile of a resist test pattern, determining a linear spread function (LSF) based on the cross-sectional profile of the resist test pattern, and estimating the PSF based on the LSF.

According to some example embodiments, the PSF may be estimated using a cross-sectional profile of the real resist test pattern. Thus, the estimated PSF may reflect developments generated during the electron-beam lithography process. Further, because an additional fitting process may not be required after estimating the PSF, estimating the PSF may be simplified. Additionally, conditions of the electron-beam lithography process may be accurately set using the PSF, so that an optical reticle may be manufactured.

### BRIEF DESCRIPTION OF THE DRAWINGS

Example embodiments will be more clearly understood from the following detailed description taken in conjunction with the accompanying drawings. FIGS. 1 to 15 represent non-limiting, example embodiments as described herein.

FIG. 1 is a cross-sectional view illustrating a resist test pattern;

FIG. 2 is a three-dimensional profile illustrating the resist test pattern in FIG. 1;

FIG. 3 is a cross-sectional view illustrating a depth profile of the resist test pattern in FIG. 1;

FIG. 4 is a cross-sectional view illustrating a depth profile of the resist test pattern in FIG. 1 in a vertical direction and a horizontal direction;

FIGS. 5A to 5C are graphs showing a method of calculating a development rate distribution;

FIG. 6 is a graph showing an exposure distribution at points on an X-direction;

FIG. 7 is a graph showing a PSF obtained using an LSF;

FIG. 8 is a block diagram illustrating a process for measuring the PSF;

FIG. 9 is a graph showing a depth profile of a resist pattern simulated by Monte Carlo simulation;

FIG. 10 is a graph showing an LSF obtained from the LRF in FIG. 9;

FIG. 11 is a graph showing a PSF;

FIG. 12 is a graph showing a PSF simulated by a Monte Carlo simulation;

FIG. 13 is a scanning electron microscope (SEM) picture showing a cross-section of the resist pattern;

FIG. 14 is a graph showing an LSF calculated using an LRF; and

FIG. 15 is a graph showing a PSF calculated using the LSF.

### DETAILED DESCRIPTION OF EXAMPLE EMBODIMENTS

Various example embodiments will be described more fully hereinafter with reference to the accompanying drawings, in which some example embodiments are shown. Example embodiments may, however, be embodied in many different forms and should not be construed as limited to the example embodiments set forth herein. Rather, these example embodiments are provided so that this disclosure will be thorough and complete, and will fully convey the scope of example embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

A method of estimating a PSF in accordance with example embodiments may be performed based on experimental data. Particularly, the PSF may be estimated using relations between the PSF and an LSF, and between the LSF and a remaining resist profile.

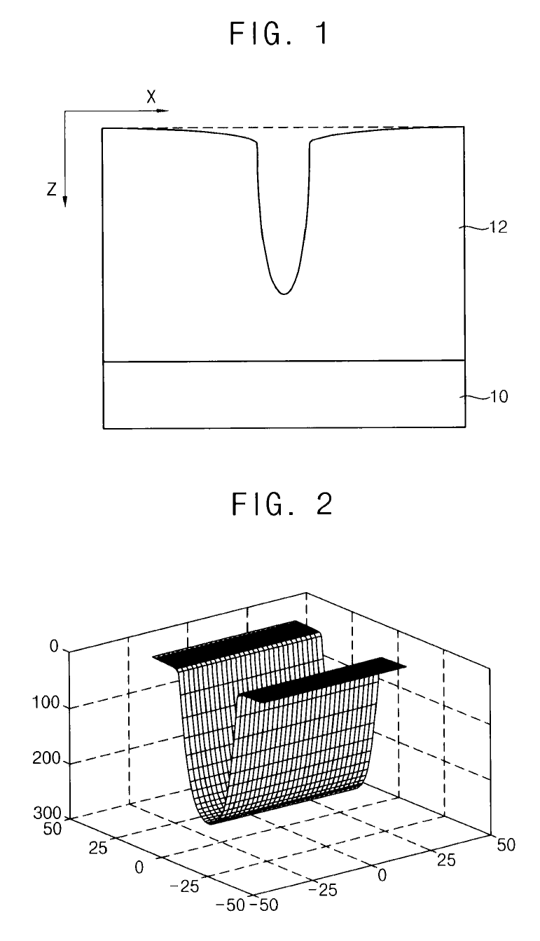

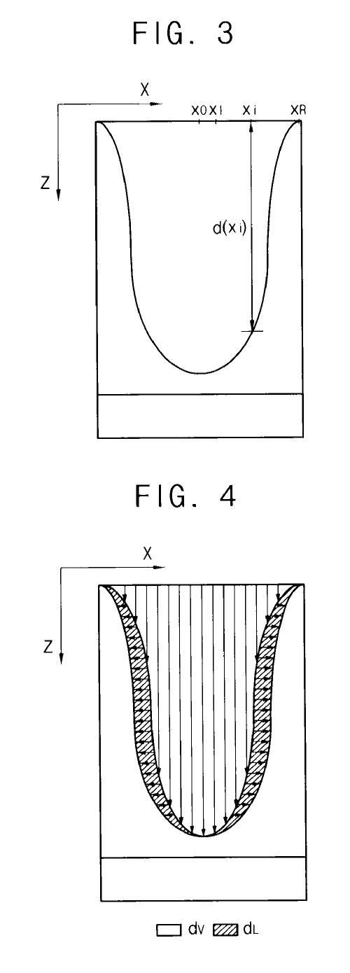

FIG. 1 is a cross-sectional view illustrating a resist test pattern, FIG. 2 is a three-dimensional profile illustrating the resist test pattern in FIG. 1, and FIG. 3 is a cross-sectional view illustrating a depth profile of the resist test pattern in FIG. 1.

Referring to FIG. 1, a resist test film (not shown) may be formed on a substrate 10. An electron beam may be irradiated to the resist test film to expose the resist film. The exposed resist film may be developed to form a resist test pattern 12. In example embodiments, the resist test pattern 12 may have a linear shape.

In example embodiments, a final profile of the resist test pattern 12 may be related to an LSF correspond to an exposure distribution when the resist film may be exposed in an extending direction of the linear resist test pattern 12. The final profile may be obtained from the resist test pattern 12 formed by the exposing process and the developing process. Thus, the final profile may reflect developments generated during the exposing process and the developing process. Further, the LSF may be calculated from an LRF. A cross-sectional profile of the resist test pattern 12 may be defined by the LRF.

Depths of the resist test pattern 12 from each of points of the resist test pattern 12 in an X-direction in FIG. 1 may be measured.

A three-dimensional profile in FIG. 2 may be obtained using the measured depths of the resist test pattern 12. Further, a cross-sectional profile, that is, the LRF in FIG. 3 may be obtained using the measured depths of the resist test pattern 12.

In example embodiments, the LRF may include front scatterings and rear scatterings of the electron beam. However, as shown in FIGS. 1-3, when the resist test pattern 12 may have a single linear pattern, the resist test pattern 12 may be very slightly affected by the rear scatterings. Thus, the rear scatterings in this example embodiment may be excluded.

A method of inducing the LSF from the LRF may include calculating a development rate distribution from the LRF, and converting development rates in the development rate distribution into an exposing dose.

In example embodiments, when the lines of the resist test pattern 12 may be substantially parallel with a Y-axis and sufficiently long so that a difference between of the lines along the Y-direction may be negligible, only a cross-section of the resist test pattern 12 substantially perpendicular to the Y-axis, as shown in FIG. 1, may be considered. Thus, a two-dimensional model excluding a cross-section of the resist test pattern 12 in the Y-direction may be applied.

When the two-dimensional model may be applied, the exposing dose and the development rate in a depth direction, i.e., a Z-direction may not be changed in the electron-beam lithography process. Therefore, the development rate distribution in the cross-section of the resist test pattern 12 may be represented by a function r(x).

The LRF, which may be a function of a profile of the resist test pattern 12, may be represented by a depth distribution profile d(x). When the development rate may be high, although the depth of the resist test pattern 12 may become deeper, d(x) may not be linearly proportional to r(x), because the resist test pattern 12 may have an isotropic sidewall by the developing process.

In FIG. 3, d(xi) at a point xi in the X-direction may be affected by r(xr) adjacent to r(xi) as well as r(x1). That is, because the resist test film may be developed in every direction during the developing process, a depth of the point xi may be affected by a development rate distribution in a region adjacent to a specific position as well as a development rate distribution in the specific point.

FIG. 4 is a cross-sectional view illustrating a depth profile of the resist test pattern in FIG. 1 in a vertical direction and a horizontal direction.

Referring to FIG. 4, although the resist test film may be developed in every direction, d(x) may be calculated using d_{V}(x) caused by vertical developments and d_{L}(x) caused by horizontal developments.

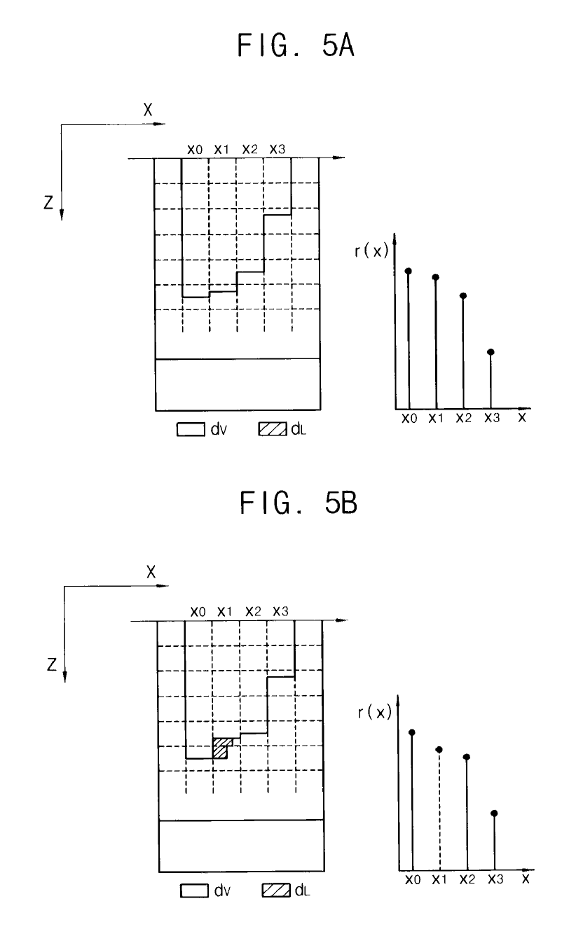

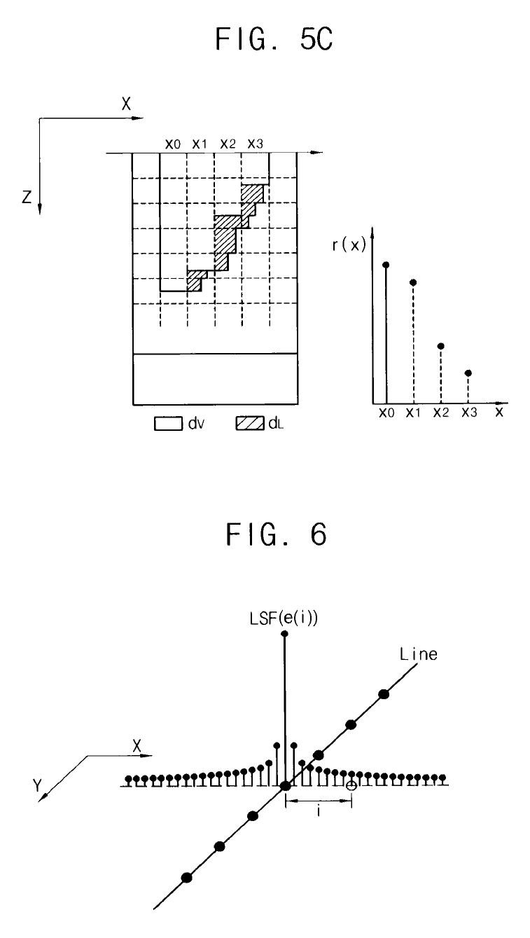

FIGS. 5A to 5C are graphs showing a method of calculating a development rate distribution.

Referring to FIG. 5A to 5C, the development rate distribution r(x) may be calculated by following two steps. When {xi} may be a set of points at which development rates may be calculated, x0 may be set as a center point of a line.

As shown in FIG. 5A, in the first step, only a vertical development at a point corresponding to the center point of the line may be considered. That is, a vertical development rate r(xi) from an initial development may be calculated by following Formula 1.

r(xi)=d_{V}(xi)/T=d(xi)/T Formula 1

In Formula 1, T represents a developing time.

In the second step, in order to calculate a horizontal development rate, r(x) may be repeatedly adjusted from the center point of the line. Because the horizontal development may not occur at the center point x0, r(x0) may be still maintained during the second step.

Because r(x1)<r(x0) at a second point x1, d(x1) may include a vertical development. As shown in FIG. 5B, a horizontal depth d_{L}(x1) may be calculated from r(x0) and r(x1). That is, a depth caused by the horizontal development d_{L}(xi) may be calculated by following Formula 2.

d_{L}(xᵢ)=G_{L}[T,r(xₖ)|k=0, 1, 2, . . . i] Formula 2

A depth error Δ1(x1) may be calculated by following Formula 3.

Δd(x1)=d_{V}(x1)+d_{L}(x1)−d(x1) Formula 3

The depth error may be used for adjusting Δr(x1) corresponding to an increment of r(x1). Thus, r(x1) may be corrected by following Formula 4.

r(x1)=r(x1)+Δr(x1) Formula 4

The distributions d_{V}(x1) and d_{L}(x1) may be re-calculated using the corrected r(x1) to obtain new Δ_{d}(x1). These processes may be repeatedly performed until Δd(x1) may be lower than a predetermined threshold value. That is, r(x1) when Δd(x1) may be no more than the threshold value may be a development rate at x1.

Referring to FIG. 5C, the calculation of the development rates may be repeated at all of xi from the center point of the line toward an outward direction. That is, the development rates at each of the points may be sequentially calculated from the center point of the line toward the outward direction. r(x) at each of the points in the X-direction may be obtained by repeating the calculation.

In example embodiments, e(xi) may mean the LSF representing an exposure distribution. After all of r(xi) may be calculated, e(xi) at each of the points may be calculated using following Formula 5. Formula 5 may be induced by experiments.

$$r ( x ) = F [ e ( x ) ] = 3700 \cdot {e}^{- {( \frac{r ( x ) - 1.0 e 11}{5.6 - 10} )}^{2}} - 152.5 \qquad Formula 5$$

In Formula 5, r(x) may have a unit of nm/minute, and e(x) may have a unit of eV/μm².

The LSF may be calculated by a dose distribution of the electron beam in a pattern having the PSF. In the LSF, the dose may be uniform along a single line. Thus, when a uniform dose may be applied, exposures at each of the points may be dependent upon a distance between corresponding points and exposed points, i.e., points where the electron beam may be applied.

FIG. 6 is a graph showing an exposure distribution at points on an X-direction.

A column vector e may be represented by a set of the LSF such as e(0), e(1) . . . , e(R). e(0) may correspond to a sample at the center point of the line in the LSF. R may correspond to a range of the electron beam scattering. A column vector p may be represented by a set of the PSF such as p(0), p(1), . . . , p(R). In some example embodiments, e may be defined on the X-axis. The line may be exposed along the Y-axis.

The exposure distribution e(i) may be calculated by summing the exposure doses at exposed points on the line. The exposure distribution e(i) may be calculated by following Formula 6.

$$\begin{matrix}e ( i ) = p ( i ) + 2 \cdot {\sum }_{k = 1}^{⌊ \sqrt{{R}^{2} - {i}^{2}} ⌋} p ( \sqrt{{i}^{2} + {k}^{2}} ) \\ = p ( i ) + 2 \cdot {\sum }_{k = 1}^{⌊ \sqrt{{R}^{2} - {i}^{2}} ⌋} ( ( ⌊ l ⌋ + 1 - l ) \cdot p ( ⌊ l ⌋ ) + ( l - ⌊ l ⌋ ) \cdot \\ p ( ⌊ l ⌋ + 1 ) )\end{matrix} \qquad Formula 6$$

where

l=\sqrt{i²+k²}

The calculated e may be represented by a multiplication of matrices. For example, the calculated e may be represented by following Formula 7.

e=A×p

In Formula 7, matrix A(i,j) may numerically express influences of p(j) on e(i).

The matrix A(i,j) may be calculated by following Formula 8.

$$A ( i , j ) = \{ \begin{matrix}0 & for i > j \\ 1 + 2 \cdot {\sum }_{k = {k}_{2}}^{{k}_{3}} ( ⌊ l ⌋ + 1 - l ) + 2 \cdot {\sum }_{k = {k}_{1}}^{{k}_{2}} ( l - ⌊ l ⌋ ) & for i = j \\ 2 \cdot {\sum }_{k = {k}_{2}}^{{k}_{3}} ( ⌊ l ⌋ + 1 - l ) + 2 \cdot {\sum }_{k = {k}_{1}}^{{k}_{2}} ( l - ⌊ l ⌋ ) & for i < j\end{matrix} \\ {k}_{1} = ⌈ \sqrt{{( j - 1 )}^{2} - {i}^{2}} ⌉ , {k}_{2} = ⌈ \sqrt{{j}^{2} - {i}^{2}} ⌉ , and {k}_{3} ⌊ \sqrt{{( j + 1 )}^{2} - {i}^{2}} ⌋ . \qquad Formula 8$$

When the vector p and the vector e may be substantially same, the square matrix A may have an inverse matrix, because the matrix A may include an upper triangle matrix. Thus, the PSF may be represented by following Formula 9.

p=A⁻¹×e Formula 9

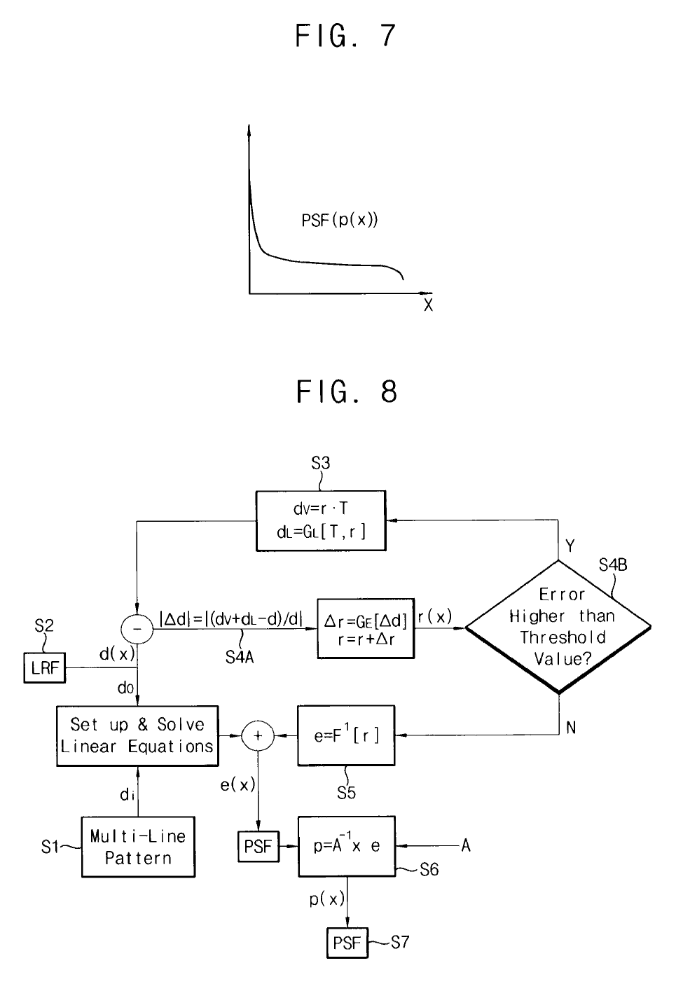

FIG. 7 is a graph showing the PSF obtained using the LSF by the above-mentioned processes.

FIG. 8 is a block diagram illustrating a process for measuring the PSF. The method shown in FIG. 4 may be performed by a lithography controller. The lithography controller is a structural element (e.g., computer processor) and is configured to control the electron-beam.

Referring to FIG. 8, in step S1, a resist test film may be formed on a substrate. An exposing process and a developing process may be performed on the resist test film to form a resist test pattern. In example embodiments, the resist test pattern may have a linear shape.

In step S2, an initial development rate distribution r(xi) may be calculated using Formula 1.

In step S3, the vertical depth d_{V}(xi) caused by the vertical development may be calculated using Formula 1. The horizontal depth d_{L}(xi) may be calculated using Formula 2.

In step S4A, the depth error Δd(x1) may be calculated using Formula 3. At S4B, the controller determines whether the depth error is higher than the threshold value.

When the depth error may be higher than the threshold value, an increment of the development rate distribution r(xi) may be calculated using following Formula 10.

Δr(xi)=G_{E}[Δd(xi)] Formula 10

In Formula 10, G_{E}[Δd(xi)] may be a function for adjusting the increment of the development rate distribution r(xi).

The step S3 may be performed using newly calculated r(xi).

In contrast, when the depth error may be lower than the threshold value, in step S5, the exposure distribution LSF may be calculated using Formula 5.

In step S6, in order to calculate the LSF at each of the points, distances between the points and the exposed points. The matrix A may be calculated based on the distances using the Formula 8.

In step S7, the PSF may be calculated based on the LSF using Formula 7.

By performing the above-mentioned processes, the PSF may be mathematically estimated based on the profile of the resist pattern. The method may include developments generated during the lithography process, so that the PSF may be actual and accurate. Further, because the PSF may be obtained by a simple experiment, the method may be applied to experimental electron-beam lithography processes to obtain the PSF.

In example embodiments, the method may consider only the front scattering. Hereinafter, a method of estimating a PSF considered the rear scattering as well as the front scattering may be explained.

When lines of a resist pattern may be in plural and the lines may have different depths, the method of estimating the PSF may include the rear scattering.

2n+1 lines may be spaced apart from each other by an interval s. Each of the lines may have substantially the same dose. A depth of a center point of each of the lines may be di (i=1, 2, 3, . . . , n+1). Here, dO may be a depth of the center point of the line. e(k,$) may be calculated by following Formula 11.

$$\begin{matrix}\{ \begin{matrix}2 \cdot {\sum }_{k = 1}^{n} e ( k \cdot s ) = {F}^{- 1} [ {d}_{1} / T ] - {F}^{- 1} [ {d}_{0} / T ] \\ 2 \cdot {\sum }_{k = 1}^{n} e ( k \cdot s ) - e ( n \cdot s ) = {F}^{- 1} [ {d}_{2} / T ] - {F}^{- 1} [ {d}_{0} / T ] \\ ⋮ \\ 2 \cdot {\sum }_{k = 1}^{n} e ( k \cdot s ) - {\sum }_{k = n + 2 - i}^{n} e ( k \cdot s ) = {F}^{- 1} [ {d}_{i} / T ] - {F}^{- 1} [ {d}_{0} / T ] \\ ⋮ \\ 2 \cdot {\sum }_{k = 1}^{n} e ( k \cdot s ) - {\sum }_{k = 2}^{n} e ( k \cdot s ) = {F}^{- 1} [ {d}_{n} / T ] - {F}^{- 1} [ {d}_{0} / T ]\end{matrix} & Formula 11\end{matrix}$$

An LSF, i.e., e(x) may be estimated by an interpolation. The LSF influenced by the rear scattering may be combined with the LSF influenced by the front scattering. The PSF may then be calculated using the two LSFs.

### Comparing PSFs Obtained by a Monte Carlo Simulation and the Method According to at Least One Example Embodiment

A resist film having a thickness of about 300 nm was formed on a substrate. The resist film included polymethylmethacrylate (PMMA). The resist film was exposed using an electron beam having energy of about 50 keV. The exposed resist film was developed to form a resist pattern. A profile of the resist pattern was simulated by Monte Carlo simulation.

Further, a resist film having a thickness of about 300 nm was formed on a substrate. The resist film included polymethylmethacrylate (PMMA). The resist film was exposed using an electron beam having energy of about 50 keV. The exposed resist film was developed to form a resist pattern. A profile of the resist pattern was simulated by the method according to at least one example embodiment.

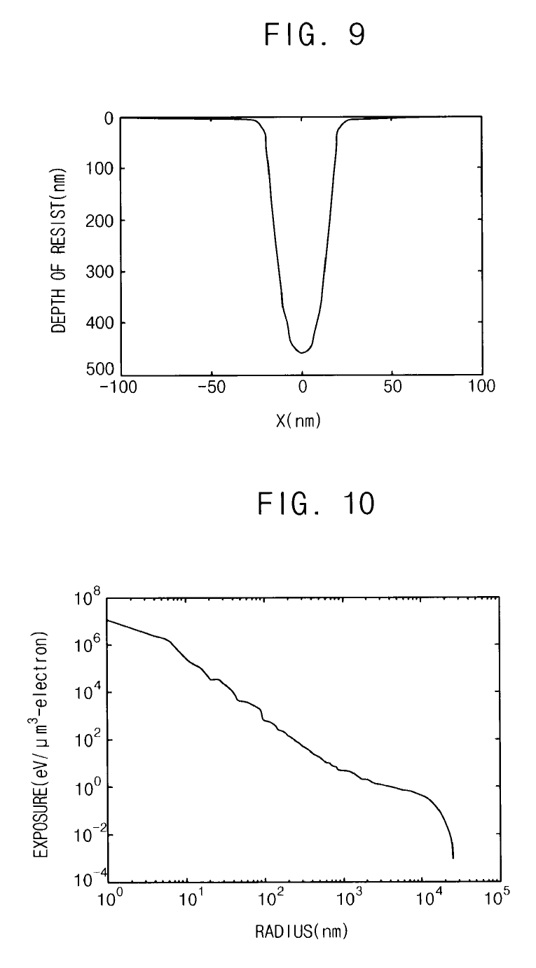

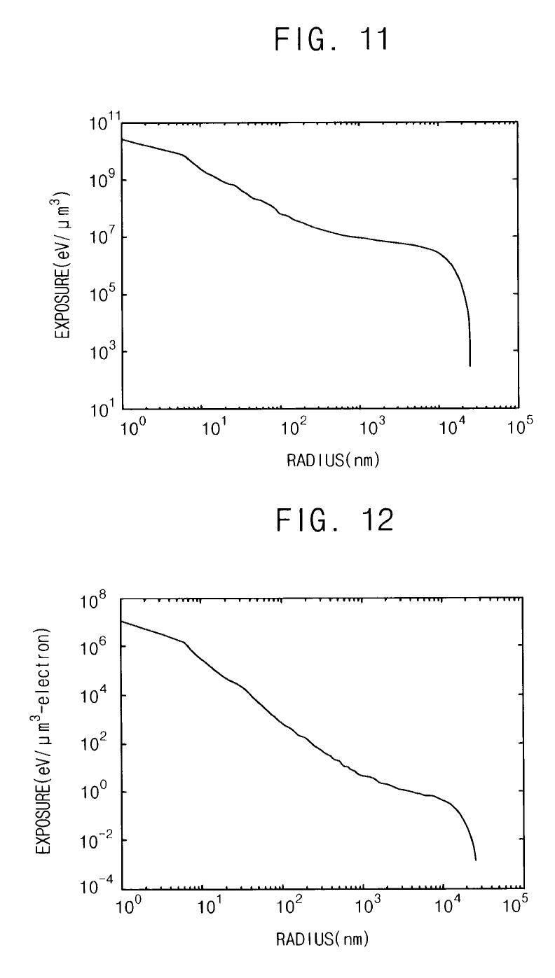

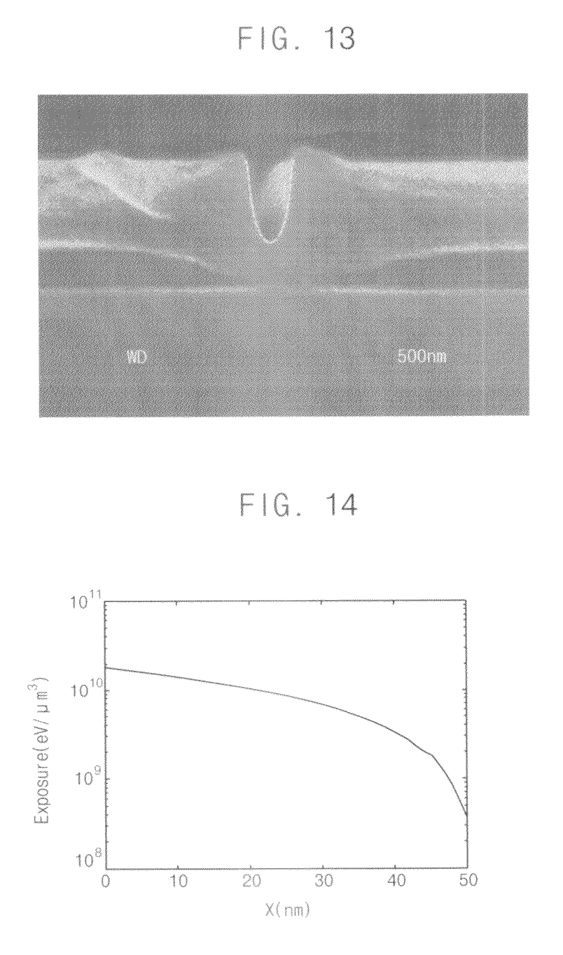

FIG. 9 is a graph showing a depth profile of a resist pattern simulated by Monte Carlo simulation, and FIG. 10 is a graph showing an LSF obtained from the LRF in FIG. 9, FIG. 11 is a graph showing a PSF obtained from the present method, and FIG. 12 is a graph showing a PSF simulated by a Monte Carlo simulation.

When FIGS. 11 and 12 may be compared with each other, the PSFs obtained by Monte Carlo simulation and the present method may have a tiny difference. Thus, it can be noted that the PSF obtained by the present method may have improved accuracy.

### Experimenting Accuracy of the Present Method

A resist film having a thickness of about 300 nm was formed on a substrate. The resist film was softly baked at a temperature of 160° C. for one minute. A developing process using a developing solution was performed on the baked resist film for 40 seconds to form a resist pattern. The developing solution included MIBK:IPA=1:2.

FIG. 13 is a scanning electron microscope (SEM) picture showing a cross-section of the resist pattern.

Referring to FIG. 13, an LRF of the resist pattern was measured using the SEM picture in FIG. 13. An LSF was calculated using the measured LRF. A PSF was estimated using the LSF.

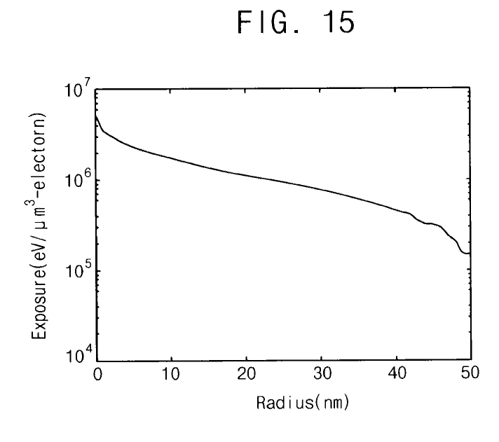

FIG. 14 is a graph showing an LSF calculated using an LRF, and FIG. 15 is a graph showing a PSF calculated using the LSF.

In order to determine whether the calculated PSF was accurate or not, an LRF was mathematically obtained using the calculated PSF. The obtained LRF was compared with the directly measured LRF from the SEM picture in FIG. 13. The calculated LRF and the measured LRF had a small error of 5.04%. Thus, it can be noted that the PSF measured by the present method is very accurate.

According to some example embodiments, the PSF may be estimated using a cross-sectional profile of the real resist test pattern. Thus, the estimated PSF may reflect developments generated during the electron-beam lithography process. Further, because an additional fitting process may not be required after estimating the PSF, estimating the PSF may be simplified. Additionally, conditions of the electron-beam lithography process may be accurately set using the PSF, so that an optical reticle may be manufactured.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of estimating a point spread function (PSF) in an electron-beam lithography process, the method comprising:
forming a linear resist test pattern on a substrate using an electron beam;
determining a line response function (LRF) using a cross-sectional profile of the linear resist test pattern;
determining a development rate distribution in a first direction using the LRF, the first direction being substantially perpendicular to an extending direction of the linear resist test pattern;
determining a line spread function (LSF) using the development rate distribution, the LSF representing an exposure distribution in the first direction; and
estimating the PSF using the LSF.

2. The method of claim 1, wherein the forming the linear resist test pattern comprises:
forming a resist film;
exposing the resist film using an electron beam; and
developing the exposed resist film to form the linear resist test pattern.

3. The method of claim 1, wherein the determining the LRF comprises:
measuring depths from points on a first axis of the first direction to a sidewall of the linear resist test pattern.

4. The method of claim 1, wherein the determining the development rate distribution comprises:
determining a first vertical development rate at a center point of the linear resist test pattern on the first axis;
determining a second vertical development rate at a second point of the linear resist test pattern spaced apart from the center point;
determining a horizontal development rate at the second point;
determining a depth error between a calculated depth of the linear resist test pattern and an actual depth of the linear resist test pattern, the calculated depth of the linear resist test pattern being based on the second vertical development rate and the horizontal development rate;
correcting the second vertical development rate and the horizontal development rate until the depth error is lower than a threshold value, if the depth error is higher than the threshold value;
determining the development rate distribution based on the second vertical development rate and the horizontal development rate.

5. The method of claim 4, further comprising:
determining a depth of the linear resist test pattern at the center point by multiplying the first vertical development rate and a developing time.

6. The method of claim 4, further comprising:
determining a depth of the linear resist test pattern at the second point by summing d_{V}(xi) and d_{L}(xi), wherein d_{V}(xi) is a vertical depth distribution profile at the second point and d_{L}(xi) is a horizontal depth distribution profile at the second point.

7. The method of claim 6, wherein the determining a depth of the linear resist test pattern includes determining the d_{L}(xi based on development rates at each of points between the center point and an endpoint of the linear resist test pattern in the first direction.

8. The method of claim 4, wherein the second point includes points between the center point and an endpoint of the linear resist test pattern, and calculating the development rates at the second point includes calculating the development rates at each of the points from the center point to the endpoint.

9. The method of claim 1, wherein the determining the LSF comprises:
using an exposure and development rate transform formula.

10. The method of claim 9, wherein the determining the LSF comprises:
calculating an exposure dose at each of points from the center point to an endpoint using development rates in the first direction determined by the exposure and development rate transform formula.

11. The method of claim 10, wherein estimating the PSF comprises:
calculating an exposure dose at each of the points from the center point to the endpoint based on distances between the center point and the points from the center point to the endpoint;
determining a matrix A, wherein
e=A×p,
e being the LSF and p being the PSF, based on the distances; and
inducing the PSF using the matrix A and the exposure distribution.

12. The method of claim 1, wherein the determining the LSF comprises:
summing exposure doses at exposed points of the linear resist test pattern.

13. The method of claim 1, wherein the determining the LSF comprises:
calculating only front scatterings, if the linear resist test pattern includes a single line.

14. The method of claim 1, wherein the determining the LSF comprises:
summing front scatterings and rear scatterings, if the linear resist test pattern includes a plurality of lines.

15. A method of estimating a point spread function (PSF), the method comprising:
determining a cross-sectional profile of a resist test pattern;
determining a linear spread function (LSF) based on the cross-sectional profile of the resist test pattern; and
estimating the PSF based on the LSF.

16. The method of claim 15, wherein the determining the LSF includes,
determining a line response function (LRF) based on the cross-sectional profile of the resist test pattern, and
determining the LSF based on the LRF.

17. The method of claim 15, wherein the determining the LSF includes using an exposure and development rate transform formula induced by electron-beam lithography.

18. The method of claim 17, wherein the determining the LSF includes determining an exposure dose at points from a center of the cross-sectional profile to an endpoint of the cross-sectional profile.
